(19) United States
(12) Patent Application Publication
(10) Pub. No.: US 2023/0078898 A1
(43) Pub. Date: Mar. 16, 2023

(54) METHOD FOR DETERMINING THE BULK DENSITY OF BULK MATERIAL IN A MOBILE CRUSHER

(71) Applicant: Rubble Master HMH GmbH, Linz (AT)

(72) Inventors: Christian Hinterdorfer, Gutau (AT); Christian Hinterreiter, Obergrünburg (AT)

(21) Appl. No.: 17/785,800

(22) PCT Filed: Apr. 26, 2021
(86) PCT No.: PCT/AT2021/060141

§ 371 Date: Jun. 15, 2022

(30) Foreign Application Priority Data
May 13, 2020 (AT) A50424/2020

(51) Int. Cl. G01N 9/02; B02C 25/00

(52) U.S. Cl. CPC G01N 9/02; B02C 25/00; G01N 2009/024

(57) ABSTRACT

A method determines the bulk density of bulk material (2) in a mobile crusher, in which the bulk material volume of bulk material (2) delivered onto a conveyor belt (1) is determined. The method is configured such that the bulk material weight can be determined reliably over a relatively prolonged operating period of a mobile crusher, even with varying bulk material density. Both the bulk material volume and the bulk material weight of a conveyor belt section (3) are sensed in successive time steps, and the bulk density is determined from the quotient of the bulk material weight and the bulk material volume.

### FIELD OF THE INVENTION

The invention relates to a method for determining the bulk density of bulk material in a mobile crusher, wherein the bulk material volume of bulk material fed onto a conveyor belt is determined.

### DESCRIPTION OF THE PRIOR ART

Many methods are known from the prior art to measure the weight of bulk material on a conveyor belt either directly via scales, or indirectly from the bulk material volume.

However, the use of common belt scales for direct measurement of weight is difficult in mobile applications, since the operating temperature, inclination of the conveyor belt, viscosity of the lubricant, etc. often change due to environmental conditions, which means that such systems often need to be calibrated. However, it is possible to determine the weight by volume. WO2017093609A1 discloses a method for determining the weight of bulk material on a conveyor belt using a scanning system that determines a three-dimensional profile of the bulk material. From this three-dimensional profile, the volume of the bulk material is detected and, together with a constant, previously known density of the bulk material, the weight is determined.

However, a disadvantage of the prior art is that volume determination is also sensitive to environmental conditions, since the sensors are very sensitive to disturbing influences such as dust or water droplets. This makes it difficult to continuously determine the conveying parameters such as the bulk material weight, bulk material volume, and quantities derived from these, such as the conveying rate per hour. In addition, the density of the bulk material must be known and constant in order to obtain reliable measured values in the long term.

### SUMMARY OF THE INVENTION

The invention is thus based on the object of being able to reliably determine the bulk material weight and bulk material volume of a mobile crusher over a longer operating period, even with varying bulk material density.

The invention solves the object by recording both the bulk material volume and the bulk material weight of a conveyor section in successive time steps and determining the bulk density from the quotient of the bulk material weight and the bulk material volume. The invention is based on the consideration that the bulk material density of the fed bulk material is known during normal operation. Nevertheless, the bulk material density is determined continuously during operation via the parallel determination of the bulk material weight and the bulk material volume and is used as a control and correction value for the proper determination of the bulk material weight. Thus, if the measuring conditions change in such a way that either the determination of the bulk material weight or the bulk material volume is impaired, the bulk material density can either temporarily no longer be determined due to missing measuring data, or its value deviates from the known bulk density, whereby such an event can be detected immediately. The bulk material volume can be determined, for example, with an optical scanning system, and the bulk material weight can be determined, for example, with a power scale.

If the bulk density of the bulk material is not known exactly, it may not be possible to determine whether and which measured values are incorrect, since no reference value is available for assessing the measured weights and volumes. However, the method can also be used with an unknown reference value for the bulk density if a bulk density mean value is formed from the bulk densities of previous time steps and a disturbance signal is output when a difference between the bulk density and the bulk density mean value is exceeded. Assuming that the bulk material volume and bulk material weight have been determined correctly for a predetermined number of time steps before the disturbance signal is output, a bulk density mean value can be formed from the bulk densities determined at these time steps, which is used for the test. This provides a reference value for the bulk density that is continuously adjusted during operation, so that the differential amount required for the output of a disturbance signal can be kept small. This disturbance signal can be transmitted to the user, for example via a wireless network. In order to check whether the weight and volume determination function properly, reference runs with measured bulk material can be carried out, for example, before the actual operation.

For example, a change in the operating temperature or location of the crusher or bulk material jammed on the conveyor belt can impair the comparability of the measurement data or lead to measurement errors. However, an incorrect determination of the bulk material weight can be corrected in this case when the disturbance signal is output by determining at least one measurement state variable of the conveyor belt for each time step and, in the case of a disturbance signal, by determining a corrected bulk material weight from the bulk material volume and the bulk density mean value if the measurement state variable of the conveyor belt deviates from the last time steps. Measurement state variables are those variables which can influence the determination of the bulk material weight, such as inclination and speed, operating temperature, orientation or location of the conveyor belt as well as the plausibility of the measurement signals. A change in the inclination and/or a change in the speed of the conveyor belt due to a change in location changes the vertically acting force component, so that a lower bulk material weight is measured for the same mass. A change in operating temperature, orientation or location can also result in changed measurement conditions due to the complex mechanics of the conveyor belt. A change in location can be detected in a simple manner, for example, by using the actuation of the trolley as a measurement condition variable. In addition, the measurement signals for the bulk material weight can be checked for plausibility and in this way, for example, transmission or other system errors in the determination of the bulk material weight can be determined. If a disturbance signal is output, the product of the bulk density mean value and the bulk material volume can be used as the corrected bulk material weight. In order to be able to continue to use the measured bulk material weight after a change in a measurement state variable of the conveyor belt, it is proposed that a correction term is determined from the bulk material weight before output of the disturbance signal and the bulk material weight after output of the disturbance signal and applied to the bulk material weights after output of the disturbance signal. For a more exact determination of the correction term, the bulk material weight before output of the disturbance signal and the bulk material weight after output of the disturbance signal can be obtained by forming the mean value from bulk material weights of several time steps.

Similarly, an incorrect determination of the bulk material volume can be easily corrected when the disturbance signal is output by determining at least one measurement state variable of the conveyor belt for each time step and, in the case of a disturbance signal, determining a corrected bulk material volume from the bulk material weight and the bulk density mean value when the measurement state variable of the conveyor belt remains constant compared to the last time steps. The measurement state variables that can be used are those described above, which can influence the determination of the bulk material weight. Due to the fact that the measurement of the bulk material volume is more susceptible to interference than the measurement of the bulk material weight due to the dust generation occurring during operation, it can be assumed that the change in the bulk density results from faulty measurements of the bulk material volume in the event that no change occurs in the measurement state variable. If a disturbance signal is output, the quotient of the bulk material weight and the bulk density mean value can be used as the corrected bulk material volume.

Meaningful measured values can be determined in the long term by recording the bulk material volume and the bulk material weight for each time step and by determining the corrected bulk material volume as the bulk material volume and/or the corrected bulk material weight as the bulk material weight for the time steps at which a disturbance signal was output. Thus, a bulk material weight, a bulk material volume and a bulk density are recorded for each time step, even when a disturbance signal is output. These measured values can subsequently be used to reliably determine other relevant parameters, such as the energy consumption of a crusher per ton of bulk material processed. In a particularly preferred embodiment of the method according to the invention, the corrected measurement results are marked so that the corrected measured values can be distinguished from the original, incorrect measured values.

### BRIEF DESCRIPTION OF THE INVENTION

In the drawing, the subject matter of the invention is shown by way of example, wherein:

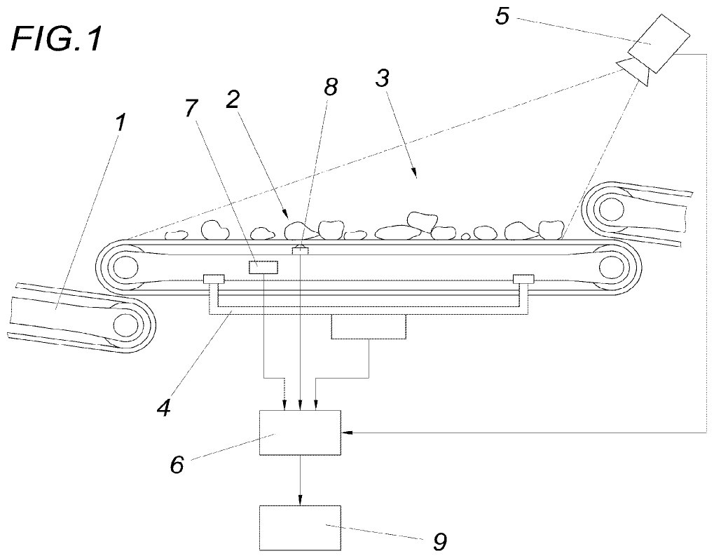

FIG. 1 shows a schematic side view of a device for carrying out the method according to the invention, and

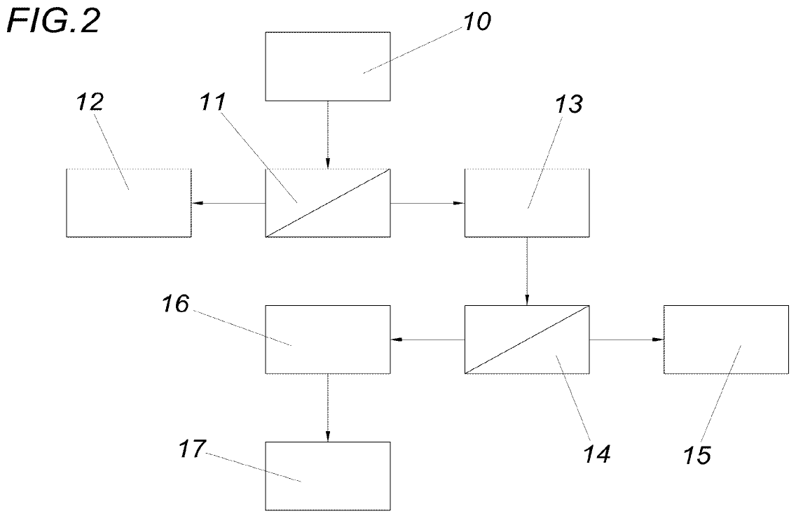

FIG. 2 shows a flow diagram of part of the method according to the invention.

### DETAILED DESCRIPTION OF THE PREFERRED EMBODIMENTS

A device for carrying out the method according to the invention comprises a conveyor belt 1 which transports bulk material 2. The bulk material 2 of a conveyor belt section 3 is measured by a scale 4 and an optical scanning system 5, wherein the scale 4 determines the bulk material weight on the conveyor belt section 3 and forwards it to a computer unit 6. The scale 4 can be, for example, a roller chair belt scale or, in a particularly preferred embodiment, an electric power scale. The optical scanning system 5 measures the bulk material 2, and also sends the measurement data to the computing unit 6, which determines the volume of the bulk material 2 from the measurement data. On the conveyor belt 1, there are also sensors for determining the measurement state variables, such as an inclination sensor 7 and a speed sensor 8, which transmit the inclination and speed of the conveyor belt to the computing unit 6. In addition, there may be sensors for determining other measurement state variables, such as the operating temperature and the position of the crusher. These may, for example, also be accommodated in the housing of the inclination sensor 7. The computing unit 6 is equipped with a disturbance signal transmitter 9, which informs a user of changes in the measurement conditions.

By means of the computing unit 6, bulk material weight, bulk material volume and bulk density are determined from the measurement data, wherein first the maximum permissible difference between bulk density and bulk density mean value and the maximum permissible change in the measurement state variables on the conveyor belt 1 are stored in the computing unit 6.

As can be seen in particular from FIG. 2, first of all in step 10 for each time step the bulk material weight, the determined bulk material volume, as well as the measurement state variables of the conveyor belt section 3 are read in, and the bulk density is determined from the bulk material weight and bulk material volume. In addition, in this step the bulk density mean value is formed from a predetermined number of bulk densities of past time steps.

In step 11, it is checked whether the maximum permissible difference between bulk density and bulk density mean value is exceeded.

If this is not the case, step 12 follows, in which the measured bulk material weight, bulk material volume and the bulk density determined from these are stored for this time step.

However, if the maximum permissible difference between the bulk density and the bulk density mean value is exceeded, step 13 follows, in which a disturbance signal is output. In step 14, it is then determined whether the maximum permissible change in the measurement state variable of the conveyor belt has been exceeded.

If this is not the case, step 15 follows, in which it is assumed that the optical scanning system 5 has supplied incorrect values for this time step and that the scale 4 supplies reliable values. The measured bulk material weight is therefore stored for this time step. The bulk material volume is determined as the quotient of the bulk material weight and the bulk density mean value determined in step 10 and stored for this time step. For this time step, the last valid bulk density or the bulk density mean value can be stored as the bulk density.

If the maximum permissible change in the measurement state variable of the conveyor belt is exceeded, step 16 follows, in which it is assumed that the scale 4 has supplied incorrect values due to the change in the measurement state variable at the conveyor belt section 3 and the optical scanning system 5 supplies reliable values. The measured bulk material volume is therefore stored for this time step. The bulk material weight is determined as the product of the bulk material volume and the bulk density mean value determined in step 10 and stored for this time step. For this time step, the last valid bulk density or the bulk density mean value can be stored as the bulk density.

1. A method for determining the bulk density of bulk material in a mobile crusher, said method comprising:
feeding a bulk material onto a conveyor belt;
detecting both a bulk material volume and a bulk material weight of the bulk material on a conveyor belt section in successive time steps; and
determining the bulk density from a quotient of the bulk material weight and the bulk material volume.

2. The method according to claim 1, wherein a bulk density mean value is derived from the bulk densities of preceding time steps, and a disturbance signal is output when a difference between the bulk density and the bulk density mean value exceeds a maximum permissible difference.

3. The method according to claim 2, wherein at least one measurement state variable of the conveyor belt is determined for each time step and, when the difference between the bulk density and the bulk density mean value exceeds the maximum permissible difference, if the measurement state variable of the conveyor belt deviates from the measurement state variable of the last time steps, a corrected bulk material weight is determined from the bulk material volume and the bulk density mean value.

4. The method according to claim 2, wherein at least one measurement state variable of the conveyor belt is determined for each time step and, when the difference between the bulk density and the bulk density mean value exceeds the maximum permissible difference, if the measurement state variable of the conveyor belt remains constant compared to the measurement state variable of the last time steps, a corrected bulk material volume is determined from the bulk material weight and the bulk density mean value.

5. The method according to claim 3, wherein the bulk material volume and the bulk material weight are recorded for each time step, and the corrected bulk material volume is determined as bulk material volume and/or the corrected bulk material weight is determined as bulk material weight for the ti me steps at which a disturbance signal was output.

6. The method according to claim 3, wherein at least one measurement state variable of the conveyor belt is determined for each time step and, when the difference between the bulk density and the bulk density mean value exceeds the maximum permissible difference, if the measurement state variable of the conveyor belt remains constant compared to the measurement state variable of the last time steps, a corrected bulk material volume is determined from the bulk material weight and the bulk density mean value.

7. The method according to claim 6, wherein the bulk material volume and the bulk material weight are recorded for each time step, and the corrected bulk material volume is determined as bulk material volume and/or the corrected bulk material weight is determined as bulk material weight for the time steps at which the disturbance signal was output.

8. The method according to claim 4, wherein the bulk material volume and the bulk material weight are recorded for each time step, and the corrected bulk material volume is determined as bulk material volume and/or the corrected bulk material weight is determined as bulk material weight for the time steps at which the disturbance signal was output.
